(19) United States
(12) Patent Application Publication
(10) Pub. No.: US 2016/0104388 A1
(43) Pub. Date: Apr. 14, 2016

(54) HIDDEN LETTER SYSTEM

(71) Applicant: GAFAR AYANTOPE DJIMA, DORAVILLE, GA (US)

(72) Inventor: GAFAR AYANTOPE DJIMA, DORAVILLE, GA (US)

(21) Appl. No.: 14/510,113

(22) Filed: Oct. 9, 2014

(51) Int. Cl. G09B 17/00; A63F 9/00; G09B 19/06

(52) U.S. Cl. CPC G09B 17/00; G09B 19/06; A63F 9/0098

(57) ABSTRACT

HIDDEN LETTER SYSTEM allows people to generate from an alphabet (original), two different alphabets. One generated from the bottom half of the original alphabet, and the other from the top half of the original alphabet. The system's utility is to have two or more people share a secret word(s) among each other through word(s) already written on their personal items without others knowing.

I, Gafar Ayantope Djima, have invented a system with which one can have separated letter(s) written on separate items, and still be able to form new letter(s) when the items get into contact in a predefined way. The new letter(s) is call hidden or secret letter(s) because it only becomes visible when the separated items get into contact, meaning it's formed from parts of the letter(s) already written the separate items. For that to be possible, the separated letters on the different items are created from parts of the hidden letter. The system comes with an index that let you know what possible visible letters can be formed from the parts of any letter if it were to become a hidden letter. A way to make the secret letter(s) easily visible is by having the parts of the letter(s), already written on the separated items, which form the new letter(s) in the same color.

The utilitarian feature of this invention is to have two or more people share a secret word(s) among each other through word(s) already written on their personal items without others knowing. Elaborations of how the system works are shown if the following examples.

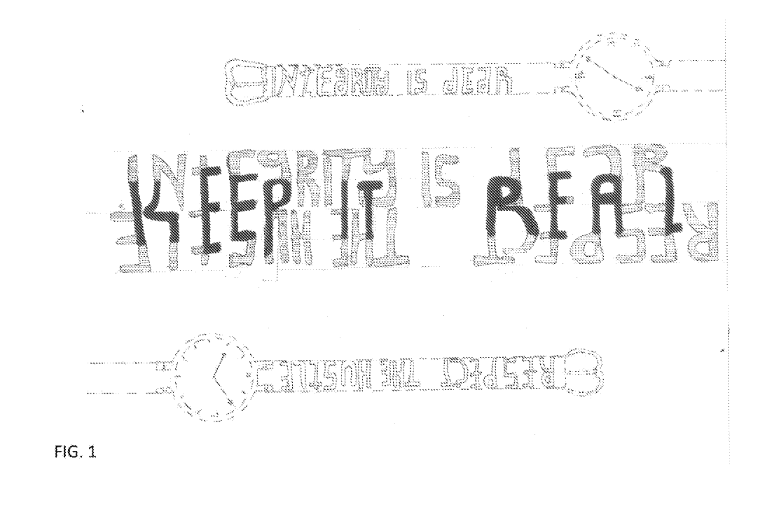

FIG. 1 shows the system being portrayed onto two different wrist-watches

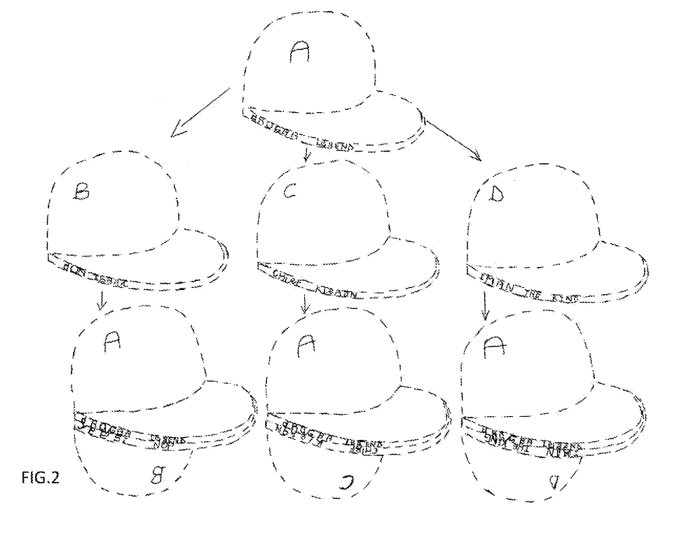

FIG. 2 shows a hat (A) using the system to share hidden words with three other different hats (B, C, and D).

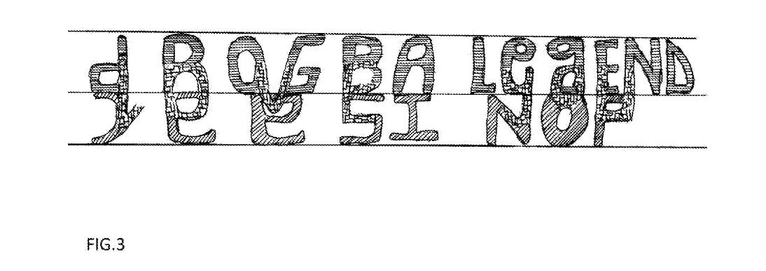

FIG. 3 is a zoom onto the words written on hat (A) and (B) from FIG. 2, and the hidden words they are sharing.

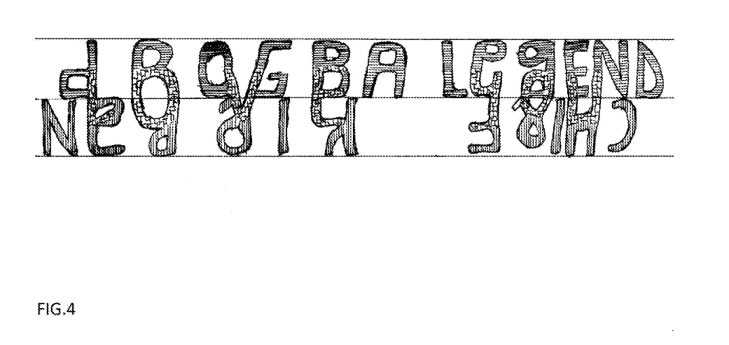

FIG. 4 is a zoom onto the words written on hat (A) and (C) from FIG. 2, and the hidden words they are sharing.

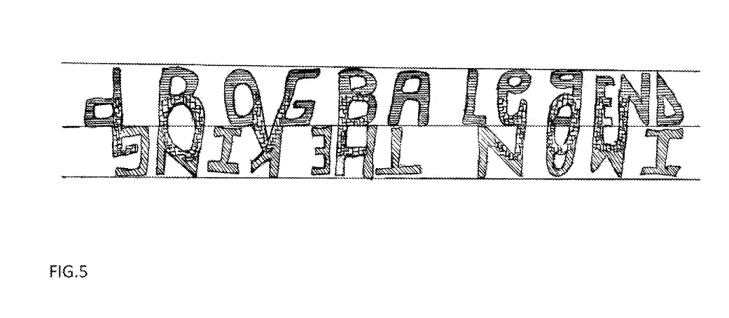

FIG. 5 is a zoom onto the words written on hat (A) and (D) from FIG. 2, and the hidden words they are sharing.

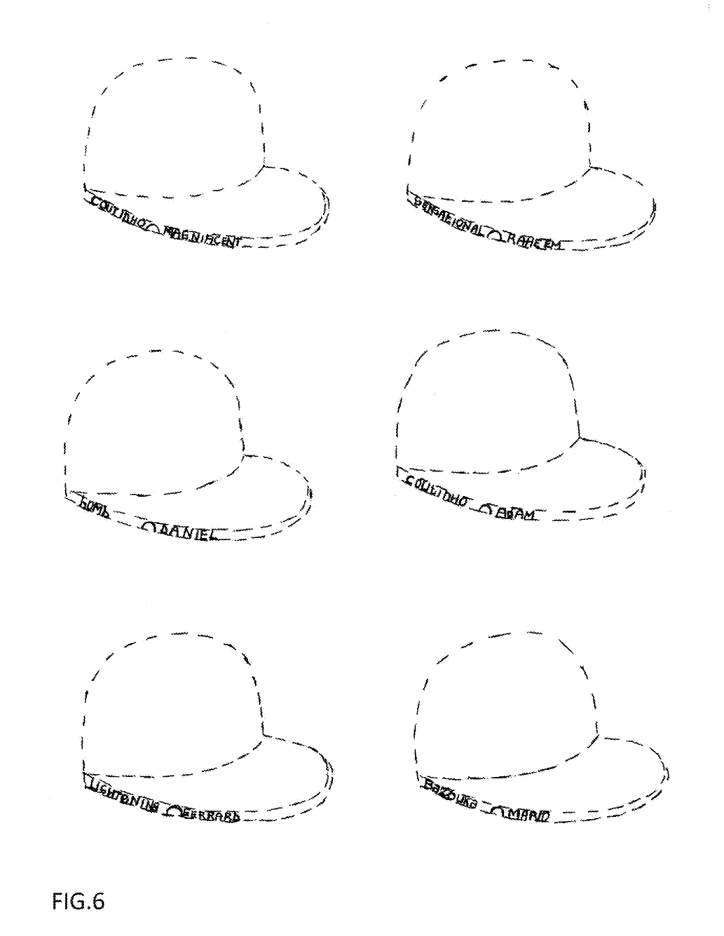

FIG. 6 shows a group of different hats.

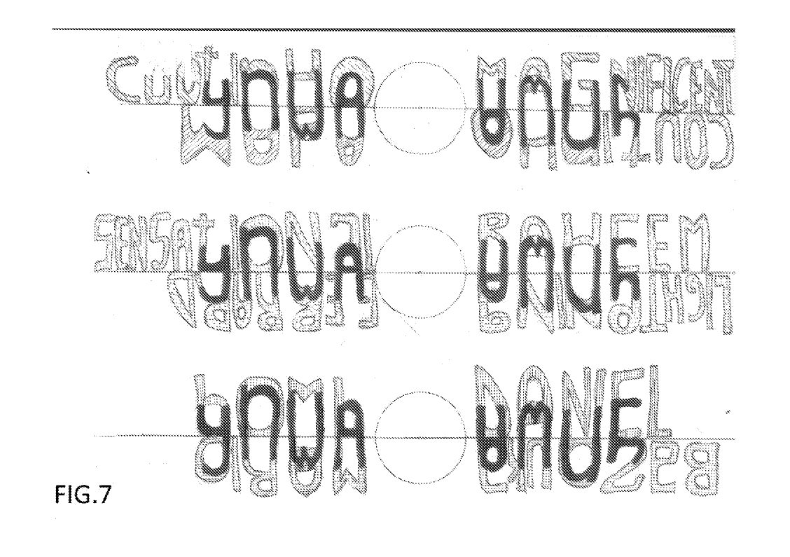

FIG. 7 shows that any of the hats from FIG. 6 can share the same secret letters with any other hat from the group.

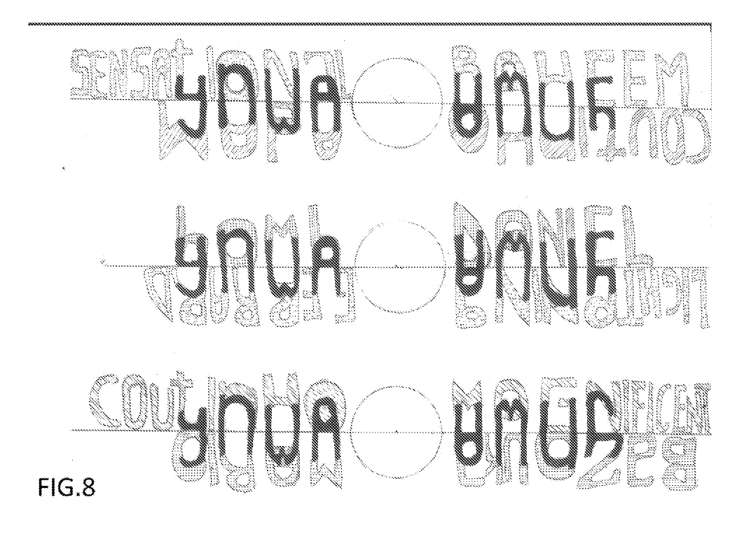

FIG. 8 shows that any of the hats from FIG. 6 can share the same secret letters with any other hat from the group.

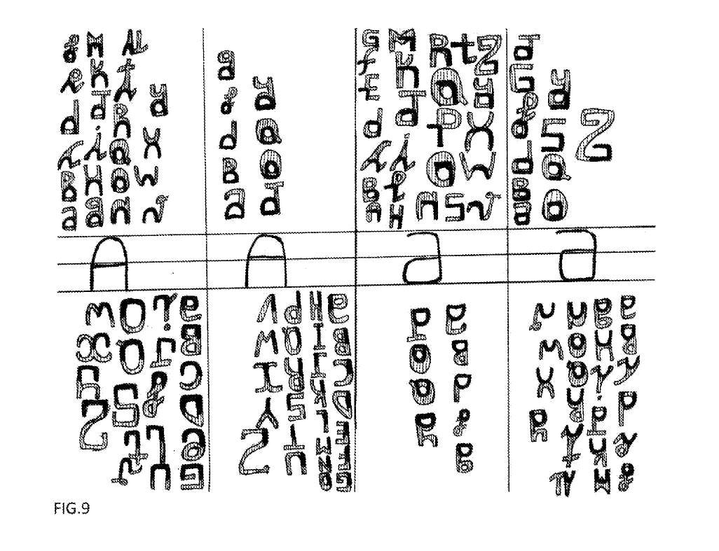

FIG. 9 shows what possible visible letters can be formed from the parts of letter “A”, if it were to become an invisible letter.

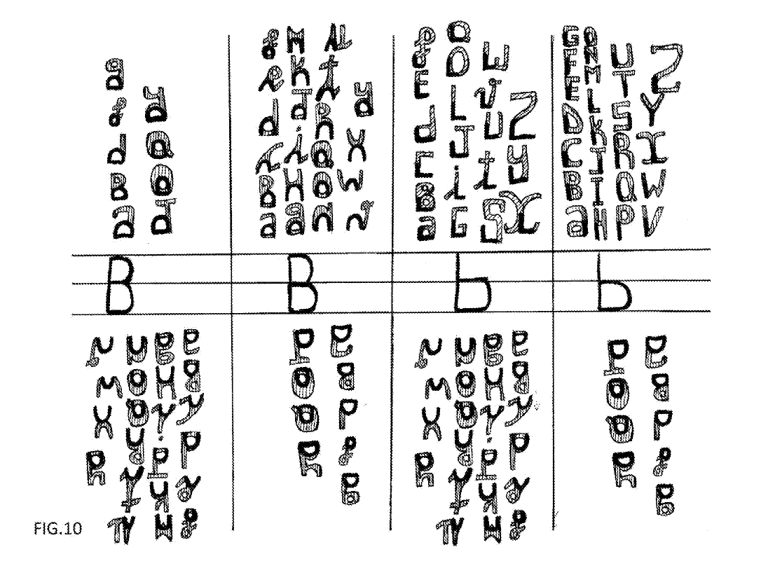

FIG. 10 shows what possible visible letters can be formed from the parts of letter “B”, if it were to become an invisible letter.

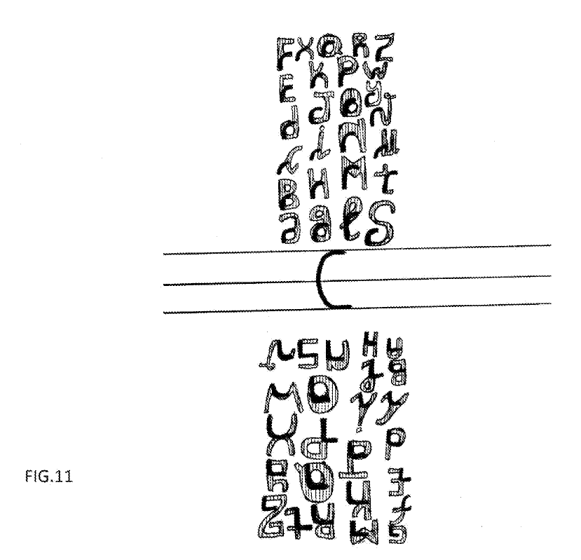

FIG. 11 shows what possible visible letters can be formed from the parts of letter “C”, if it were to become an invisible letter.

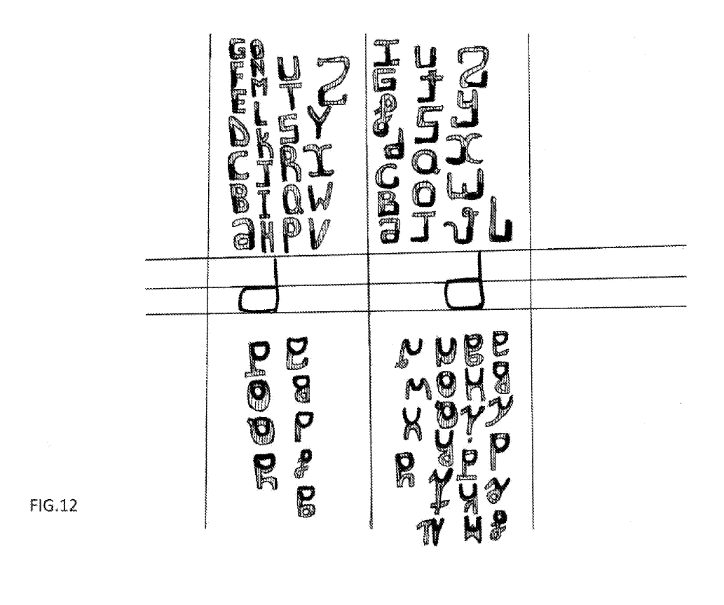

FIG. 12 shows what possible visible letters can be formed from the parts of letter “D”, if it were to become an invisible letter.

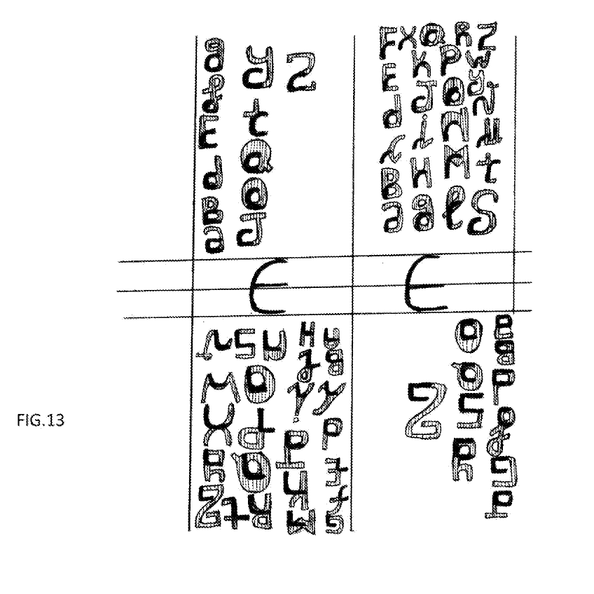

FIG. 13 shows what possible visible letters can be formed from the parts of letter “E”, if it were to become an invisible letter.

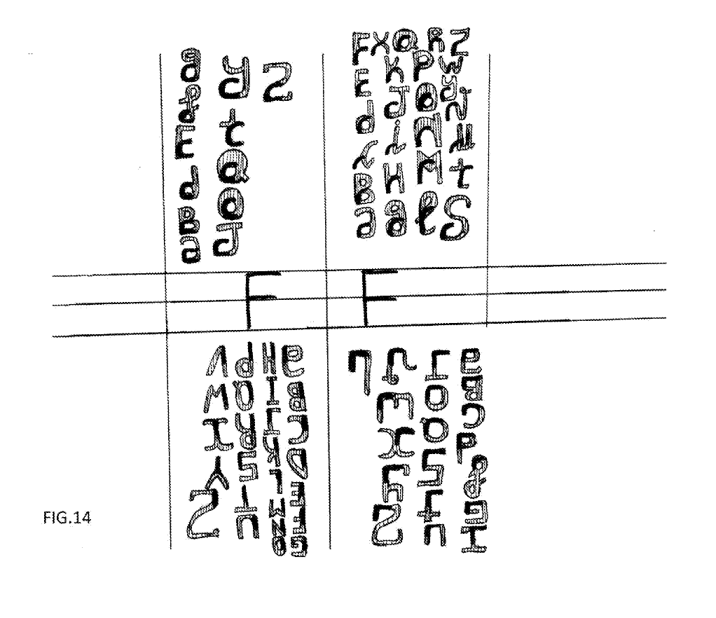

FIG. 14 shows what possible visible letters can be formed from the parts of letter “F”, if it were to become an invisible letter.

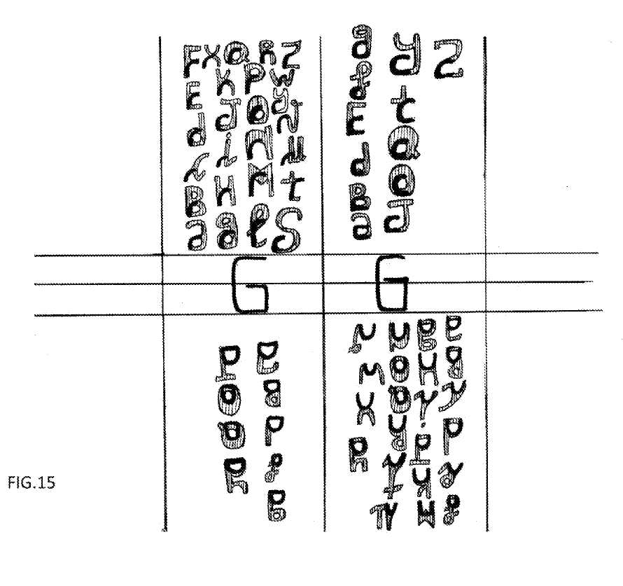

FIG. 15 shows what possible visible letters can be formed from the parts of letter “G”, if it were to become an invisible letter.

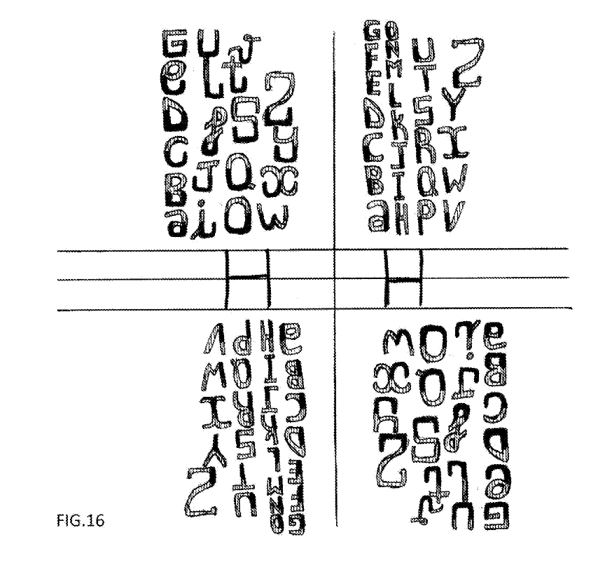

FIG. 16 shows what possible visible letters can be formed from the parts of letter “H”, if it were to become an invisible letter.

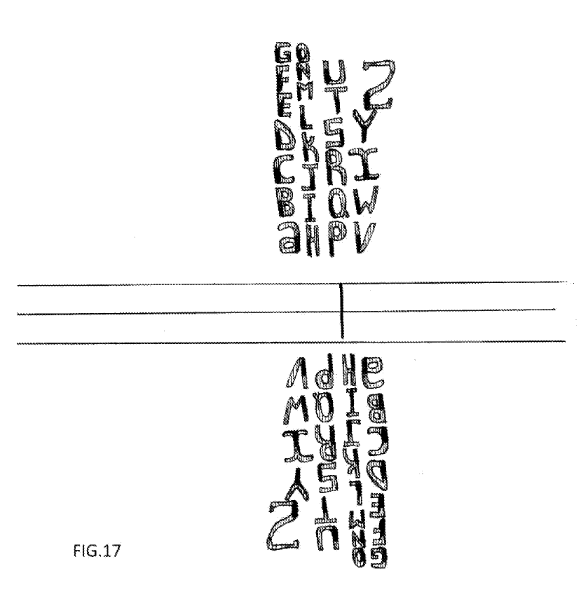

FIG. 17 shows what possible visible letters can be formed from the parts of letter “I”, if it were to become an invisible letter.

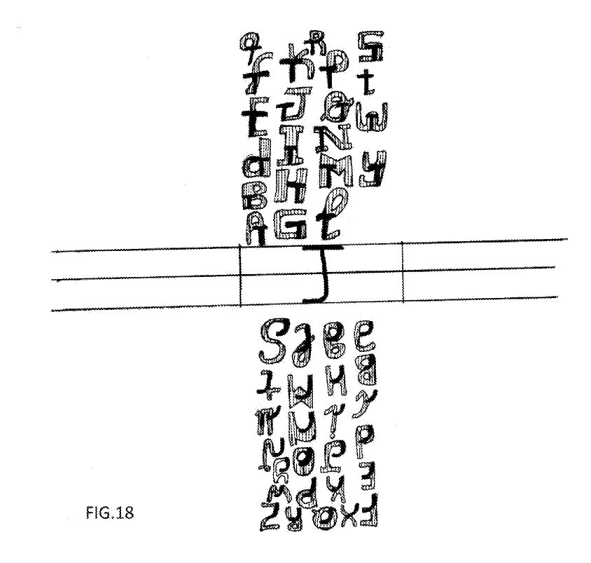

FIG. 18 shows what possible visible letters can be formed from the parts of letter “J”, if it were to become an invisible letter.

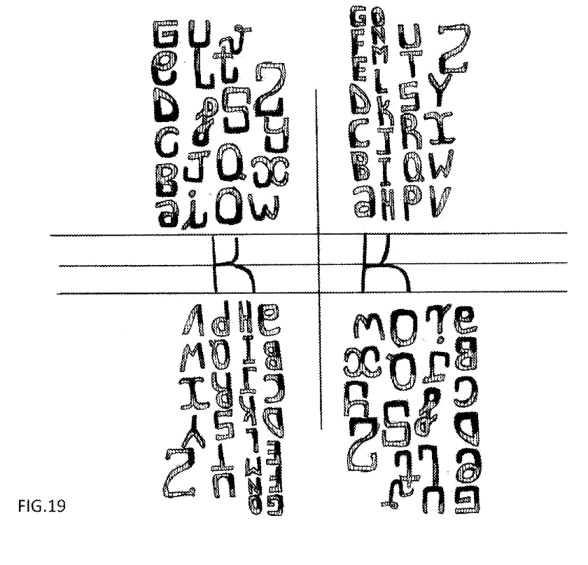

FIG. 19 shows what possible visible letters can be formed from the parts of letter “K”, if it were to become an invisible letter.

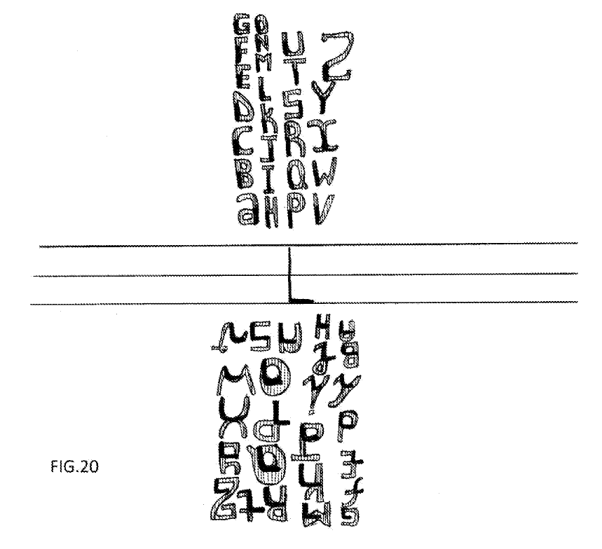

FIG. 20 shows what possible visible letters can be formed from the parts of letter “L”, if it were to become an invisible letter.

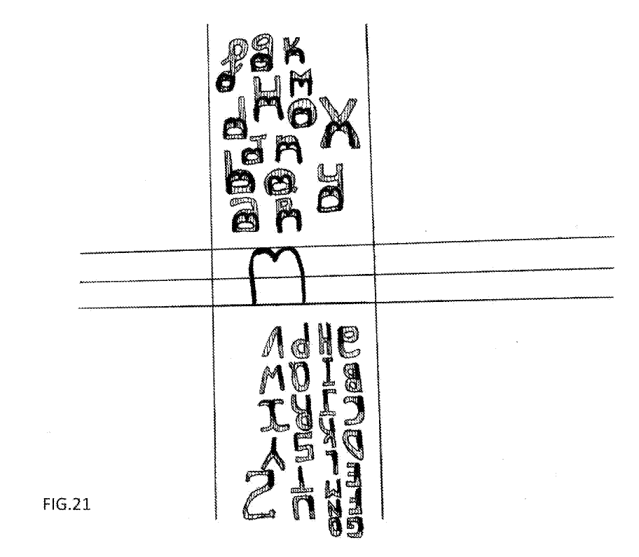

FIG. 21 shows what possible visible letters can be formed from the parts of letter “M”, if it were to become an invisible letter.

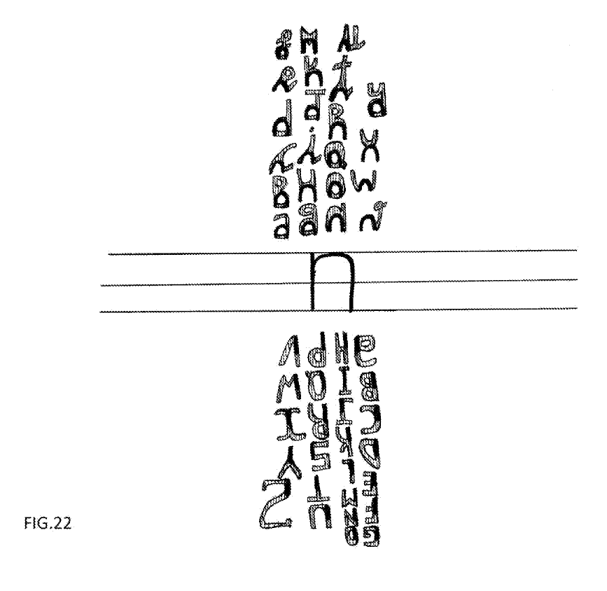

FIG. 22 shows what possible visible letters can be formed from the parts of letter “N”, if it were to become an invisible letter.

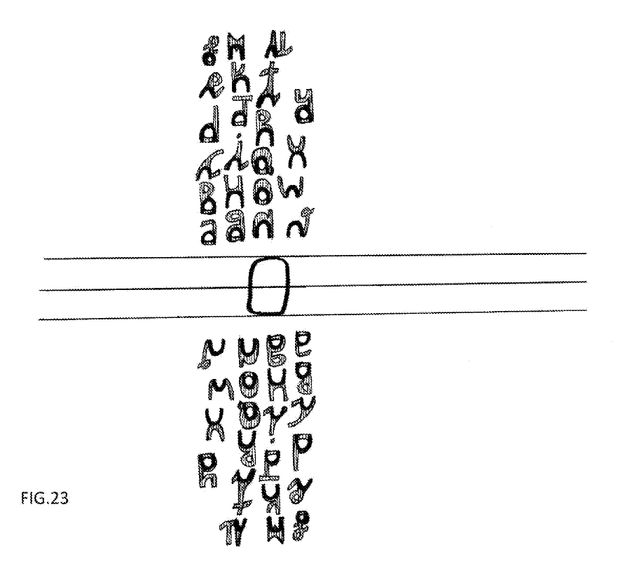

FIG. 23 shows what possible visible letters can be formed from the parts of letter “O”, if it were to become an invisible letter.

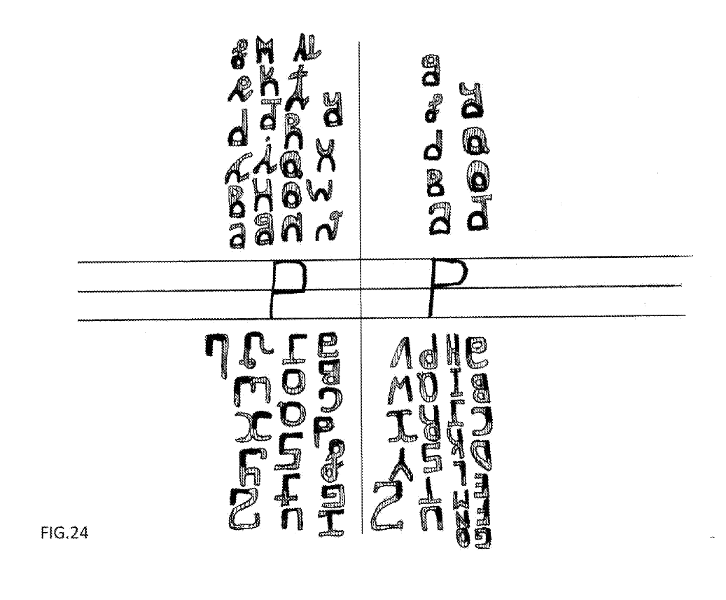

FIG. 24 shows what possible visible letters can be formed from the parts of letter “P”, if it were to become an invisible letter.

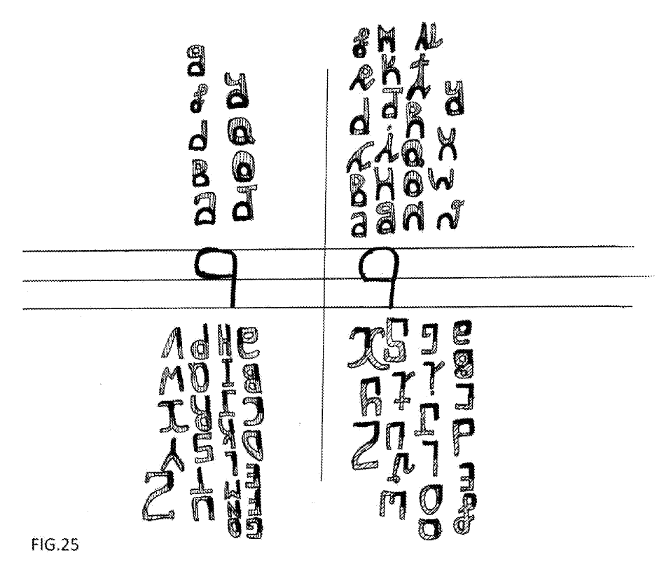

FIG. 25 shows what possible visible letters can be formed from the parts of letter “Q”, if it were to become an invisible letter.

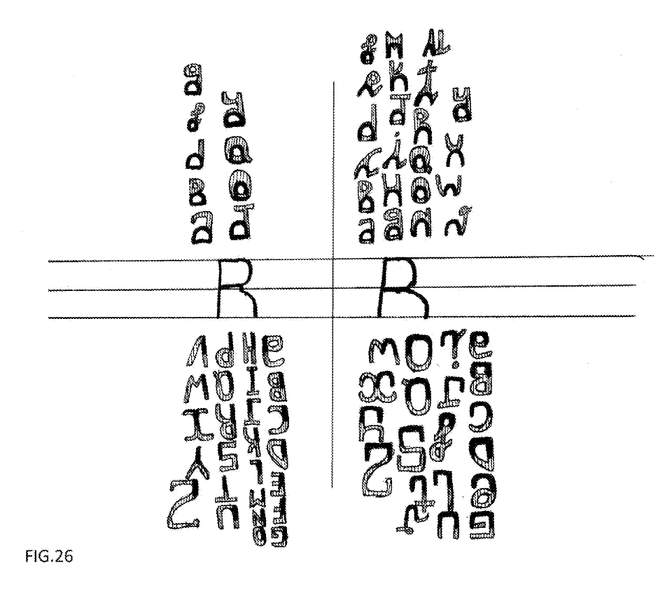

FIG. 26 shows what possible visible letters can be formed from the parts of letter “R”, if it were to become an invisible letter.

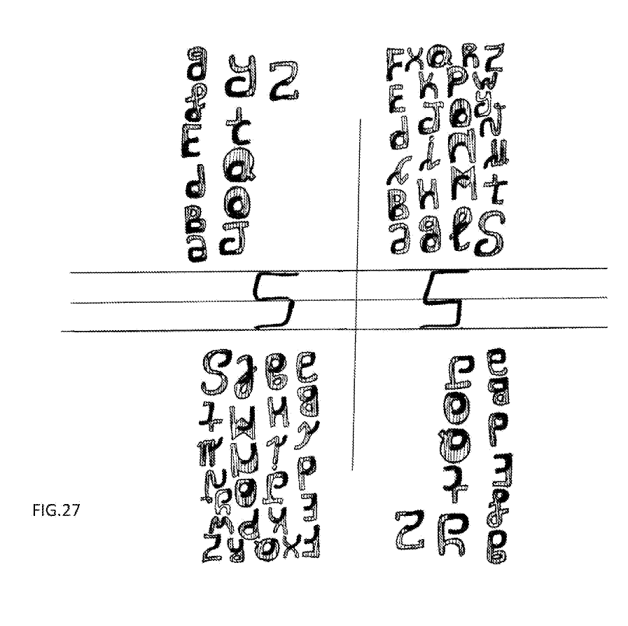

FIG. 27 shows what possible visible letters can be formed from the parts of letter “S”, if it were to become an invisible letter.

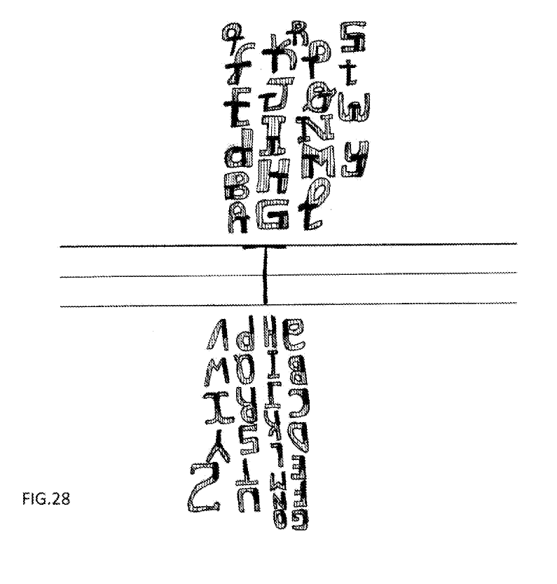

FIG. 28 shows what possible visible letters can be formed from the parts of letter “T”, if it were to become an invisible letter.

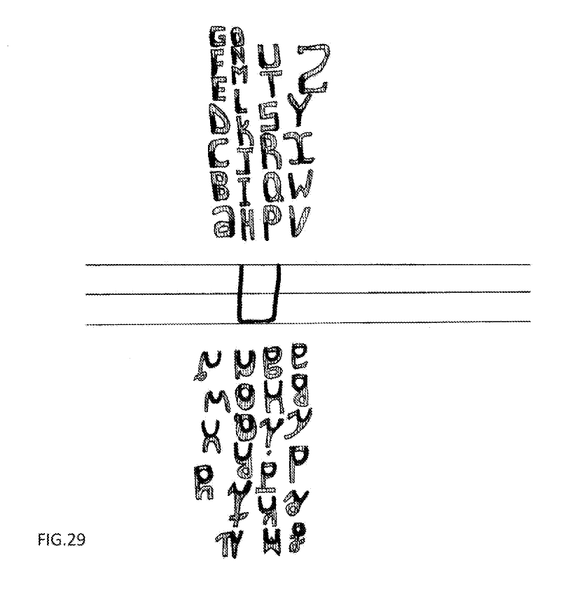

FIG. 29 shows what possible visible letters can be formed from the parts of letter “U”, if it were to become an invisible letter.

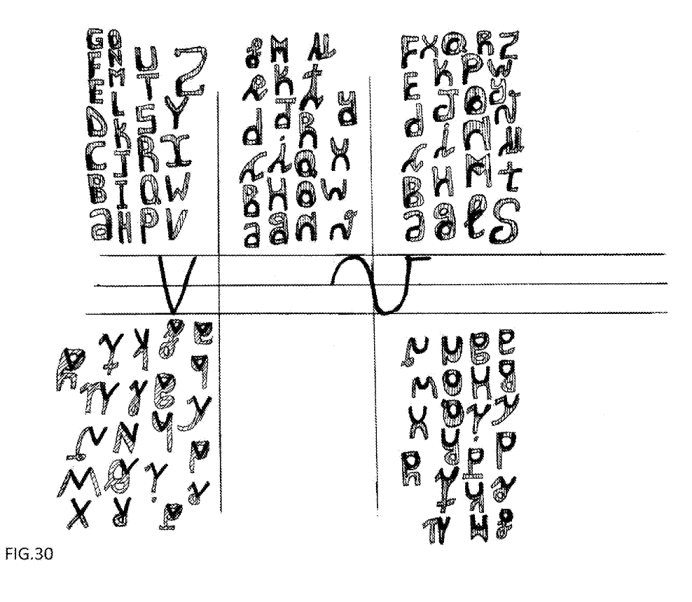

FIG. 30 shows what possible visible letters can be formed from the parts of letter “V”, if it were to become an invisible letter.

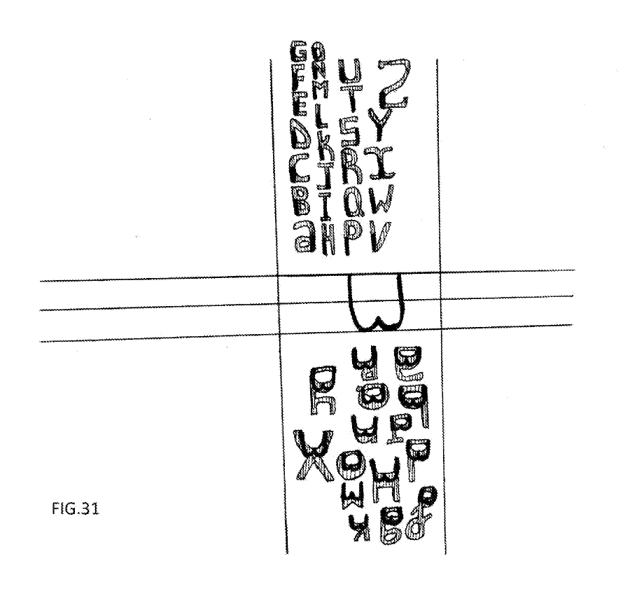

FIG. 31 shows what possible visible letters can be formed from the parts of letter “W”, if it were to become an invisible letter.

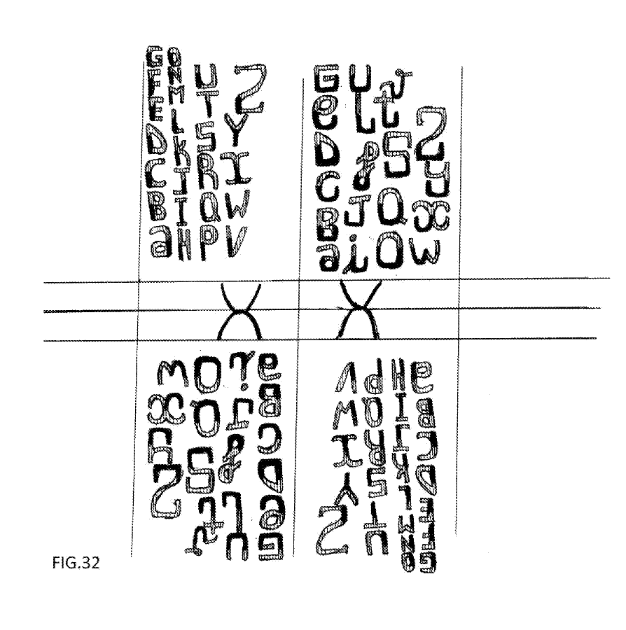

FIG. 32 shows what possible visible letters can be formed from the parts of letter “X”, if it were to become an invisible letter.

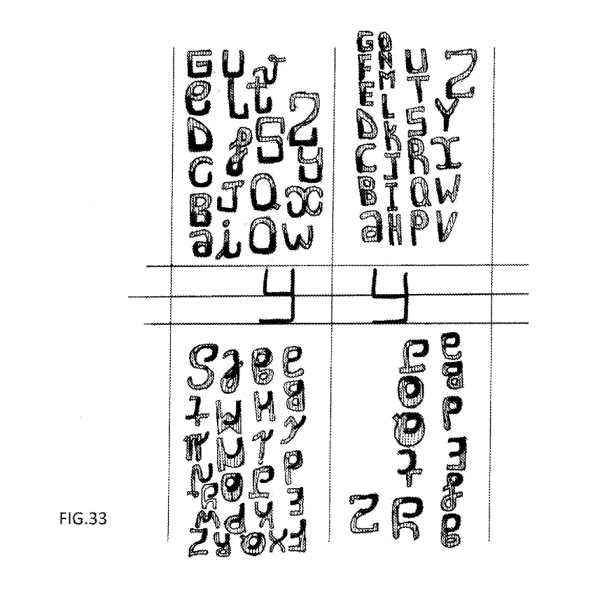

FIG. 33 shows what possible visible letters can be formed from the parts of letter “Y”, if it were to become an invisible letter.

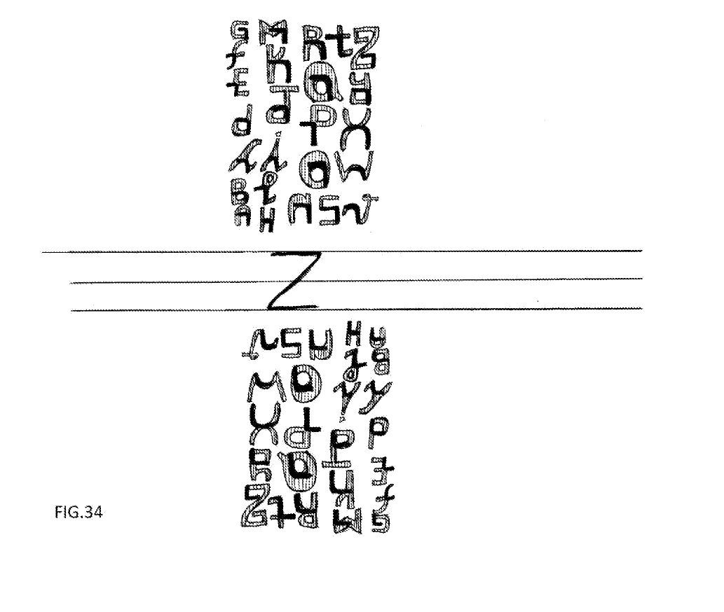

FIG. 34 shows what possible visible letters can be formed from the parts of letter “Z”, if it were to become an invisible letter.

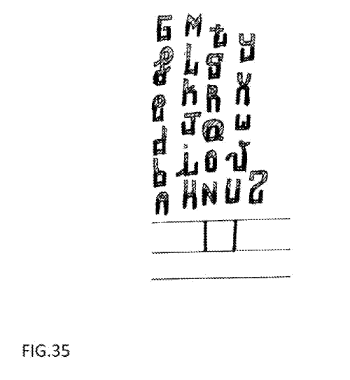

FIG. 35 shows what possible visible letters can be formed in-between two lines that may or may not be from the same letter.

I claim: the invention of the system that allows two or more people to share a secret letter(s) among each other through letter(s) already written on their personal items without others knowing.

Drawing Disclosure:

1. I claim: creating letter a, b, c, d, e, f, g, h, I, j, k, l, m, n, o, p, q r, s, t, u, v, w, x, y, and z from the top half of letter a:
I claim: creating letter A, B, C, D, E, F, G, H, I, J, K, L, M, N, O, P, Q R, S, T, U, V, W, X, Y, and Z from the bottom half of letter A.
I claim: creating letter A, B, C, D, E, F, G, H, I, J, K, L, M, N, O, P, Q R, S, T, U, V, W, X, Y, and Z from the top half of letter B.
I claim: creating letter A, B, C, D, E, F, G, H, I, J, K, M, N, O, Q R, T, U, V, W, X, and Y from the bottom half of letter B.
I claim: creating letter A, B, C, D, E, F, G, H, I, J, K, L, M, N, O, P, Q R, S, T, V, W, X, Y, and Z from the top half of letter C.
I claim: creating letter A, B, C, D, E, F, G, H, I, J, K, L, M, N, O, P, Q R, S, T, V, W, X, Y, and Z from the bottom half of letter C.
I claim: creating letter A, B, C, D, E, F, G, H, I, J, K, L, M, N, O, P, Q R, S, T, U, V, W, X, Y, and Z from the top half of letter D.
I claim: creating letter A, B, C, D, E, F, G, H, I, J, K, M, N, O, Q R, T, U, V, W, X, and Y from the bottom half of letter D.
I claim: creating letter A, B, C, D, E, F, G, H, I, J, K, L, M, N, O, P, Q R, S, T, U, V, W, X, Y, and Z from the top half of letter E.
I claim: creating letter A, B, C, D, E, F, G, H, I, J, K, L, M, N, O, P, Q R, S, T, V, W, X, Y, and Z from the bottom half of letter E.
I claim: creating letter A, B, C, D, E, F, G, H, I, J, K, L, M, N, O, P, Q R, S, T, U, V, W, X, Y, and Z from the top half of letter F.
I claim: creating letter A, B, C, D, E, F, G, H, I, J, K, L, M, N, O, P, Q R, S, T, U, V, W, X, Y, and Z from the bottom half of letter F.
I claim: creating letter A, B, C, D, E, F, G, H, I, J, K, L, M, N, O, P, Q R, S, T, U, V, W, X, Y, and Z from the top half of letter G.
I claim: creating letter A, B, C, D, E, F, G, H, I, J, K, M, N, O, Q R, T, U, V, W, X, and Y from the bottom half of letter G.
I claim: creating letter A, B, C, D, E, F, G, H, I, J, K, L, M, N, O, P, Q R, S, T, U, V, W, X, Y, and Z from the top half of letter H.
I claim: creating letter A, B, C, D, E, F, G, H, I, J, K, L, M, N, O, P, Q R, S, T, U, V, W, X, Y, and Z from the bottom half of letter H.
I claim: creating letter A, B, C, D, E, F, G, H, I, J, K, L, M, N, O, P, Q R, S, T, U, V, W, X, Y, and Z from the top half of letter I.
I claim: creating letter A, B, C, D, E, F, G, H, I, J, K, L, M, N, O, P, Q R, S, T, U, V, W, X, Y, and Z from the bottom half of letter I
I claim: creating letter A, B, D, E, F, G, H, I, J, K, L, M, N, O, P, Q R, S, T, W, and Y from the top half of letter J.
I claim: creating letter A, B, C, D, E, F, G, H, I, J, K, L, M, N, O, P, Q R, S, T, U, V, W, X, Y, and Z from the bottom half of letter J.
I claim: creating letter A, B, C, D, E, F, G, H, I, J, K, L, M, N, O, P, Q R, S, T, U, V, W, X, Y, and Z from the top half of letter K.
I claim: creating letter A, B, C, D, E, F, G, H, I, J, K, L, M, N, O, P, Q R, S, T, U, V, W, X, Y, and Z from the bottom half of letter K.
I claim: creating letter A, B, C, D, E, F, G, H, I, J, K, L, M, N, O, P, Q R, S, T, U, V, W, X, Y, and Z from the top half of letter L.
I claim: creating letter A, B, C, D, E, F, G, H, I, J, K, L, M, N, O, P, Q R, S, T, V, W, X, Y, and Z from the bottom half of letter L.
I claim: creating letter A, B, D, F, G, H, J, K, M, N, O, Q R, X, and Y from the top half of letter M.
I claim: creating letter A, B, C, D, E, F, G, H, I, J, K, L, M, N, O, P, Q R, S, T, U, V, W, X, Y, and Z from the bottom half of letter M.
I claim: creating letter A, B, C, D, E, F, G, H, I, J, K, M, N, O, Q R, T, U, V, W, X, and Y from the top half of letter N.
I claim: creating letter A, B, C, D, E, F, G, H, I, J, K, L, M, N, O, P, Q R, S, T, U, V, W, X, Y, and Z from the bottom half of letter N.
I claim: creating letter A, B, C, D, E, F, G, H, I, J, K, M, N, O, Q R, S, T, U, V, W, X, and Y from the top half of letter O.
I claim: creating letter A, B, C, D, E, F, G, H, I, J, K, M, N, O, Q R, S, T, U, V, W, X, and Y from the bottom half of letter O.
I claim: creating letter A, B, C, D, E, F, G, H, I, J, K, M, N, O, Q R, S, T, U, V, W, X, and Y from the top half of letter P.
I claim: creating letter A, B, C, D, E, F, G, H, I, J, K, L, M, N, O, P, Q R, S, T, U, V, W, X, Y, and Z from the bottom half of letter P.
I claim: creating letter A, B, C, D, E, F, G, H, I, J, K, M, N, O, Q R, S, T, U, V, W, X, and Y from the top half of letter Q.
I claim: creating letter A, B, C, D, E, F, G, H, I, J, K, L, M, N, O, P, Q R, S, T, U, V, W, X, Y, and Z from the bottom half of letter Q.
I claim: creating letter A, B, C, D, E, F, G, H, I, J, K, M, N, O, Q R, S, T, U, V, W, X, and Y from the top half of letter R.
I claim: creating letter A, B, C, D, E, F, G, H, I, J, K, L, M, N, O, P, Q R, S, T, U, V, W, X, Y, and Z from the bottom half of letter R.
I claim: creating letter A, B, C, D, E, F, G, H, I, J, K, L, M, N, O, P, Q R, S, T, U, V, W, X, Y, and Z from the top half of letter S.
I claim: creating letter A, B, C, D, E, F, G, H, I, J, K, L, M, N, O, P, Q R, S, T, U, V, W, X, Y, and Z from the bottom half of letter S.
I claim: creating letter A, B, D, E, F, G, H, I, J, K, L, M, N, O, P, Q R, S, T, W, and Y from the top half of letter T.
I claim: creating letter A, B, C, D, E, F, G, H, I, J, K, L, M, N, O, P, Q R, S, T, U, V, W, X, Y, and Z from the bottom half of letter T.
I claim: creating letter A, B, C, D, E, F, G, H, I, J, K, L, M, N, O, P, Q R, S, T, U, V, W, X, Y, and Z from the top half of letter U.
I claim: creating letter A, B, C, D, E, F, G, H, I, J, K, M, N, O, Q R, S, T, U, V, W, X, and Y from the bottom half of letter U.
I claim: creating letter A, B, C, D, E, F, G, H, I, J, K, L, M, N, O, P, Q R, S, T, U, V, W, X, Y, and Z from the top half of letter V.
I claim: creating letter A, B, C, D, E, F, G, H, I, J, K, M, N, O, Q R, S, T, U, V, W, X, and Y from the bottom half of letter V.
I claim: creating letter A, B, C, D, E, F, G, H, I, J, K, L, M, N, O, P, Q R, S, T, U, V, W, X, Y, and Z from the top half of letter W.
I claim: creating letter A, B, D, F, G, H, J, K, M, N, O, Q R, X, and Y from the bottom half of letter W.
I claim: creating letter A, B, C, D, E, F, G, H, I, J, K, L, M, N, O, P, Q R, S, T, U, V, W, X, Y, and Z from the top half of letter X.
I claim: creating letter A, B, C, D, E, F, G, H, I, J, K, L, M, N, O, P, Q R, S, T, U, V, W, X, Y, and Z from the bottom half of letter X.
I claim: creating letter A, B, C, D, E, F, G, H, I, J, K, L, M, N, O, P, Q R, S, T, U, V, W, X, Y, and Z from the top half of letter Y.
I claim: creating letter A, B, C, D, E, F, G, H, I, J, K, L, M, N, O, P, Q R, S, T, U, V, W, X, Y, and Z from the bottom half of letter Y.
I claim: creating letter A, B, C, D, E, F, G, H, I, J, K, L, M, N, O, P, Q R, S, T, U, V, W, X, Y, and Z from the top half of letter Z.
I claim: creating letter A, B, C, D, E, F, G, H, I, J, K, L, M, N, O, P, Q R, S, T, V, W, X, Y, and Z from the bottom half of letter Z.
